(19) United States
(12) Patent Application Publication
(10) Pub. No.: US 2026/0355947 A1
(43) Pub. Date: Nov. 12, 2026

(54) SYSTEMS AND METHODS FOR GENERATING PLANNING DOMAINS USING LARGE LANGUAGE MODELS

(71) Applicant: HUAWEI TECHNOLOGIES CO., LTD., SHENZHEN (CN)

(72) Inventors: Jinbang HUANG, Kanata (CA); Zhanguang ZHANG, Kanata (CA); Yingxue ZHANG, Kanata (CA)

(73) Assignee: HUAWEI TECHNOLOGIES CO., LTD., SHENZHEN (CN)

(21) Appl. No.: 19/200,188

(22) Filed: May 6, 2025

(51) Int. Cl. B25J 9/16; G06Q 10/0631

(52) U.S. Cl. CPC B25J 9/163; G06Q 10/06316

(57) ABSTRACT

The present disclosure relates to automated planning systems and generating planning domains using large language models. Current methods often require manual creation or predefined knowledge. Disclosed are systems and methods that automatically generate planning domains, including predicate libraries defining state properties (potentially via predicate imagination) and action libraries defining state transitions (potentially via action generation). These libraries are derived from inputs like task descriptions and human demonstrations, possibly using physical simulation and LLMs. This generation of planning domain may avoid requiring predefined logical predicates or actions. This automated approach may reduce manual effort and prior knowledge dependency, which may enhance flexibility and scalability for guiding automated task execution in diverse systems including robotics, autonomous driving, or software agents. A logic-constrained action sampler can further translate high-level logical plans into constrained motion plans for execution.

### CROSS-REFERENCE TO RELATED APPLICATIONS

This is the first application filed for the present disclosure.

### FIELD OF THE DISCLOSURE

The present disclosure relates generally to planning systems, and in particular to systems and methods for generating or automatically generating planning domains using large language models.

### BACKGROUND

Robotic systems are increasingly utilized for various tasks. While robots may perform well in structured environments on short-term tasks, challenges arise with long-horizon tasks requiring abstract reasoning and adaptability. Task and Motion Planning (TAMP) frameworks aim to address this by integrating high-level task reasoning with low-level motion planning. An aspect of TAMP involves defining planning domains, which are formal representations of actions, states, and goals used to guide plan generation. However, the manual creation of these domains can be labor-intensive and may limit the flexibility and scalability of planning systems.

Recent developments have explored automating the generation of planning domains or utilizing large language models (LLMs) for planning. LLM-based planners leverage embedded knowledge but can face limitations with complex, long-horizon reasoning. Other approaches use LLM-generated heuristics to improve planning efficiency, often integrating symbolic search strategies. These heuristic methods, however, typically presuppose the existence of a pre-constructed symbolic planning domain, adding complexity.

Efforts to automate planning domain generation have included optimization-based techniques to infer logical predicates or actions, which can be computationally expensive. More recently, language models have been employed for domain generation, such as translating natural language descriptions into structured planning languages or learning additional predicates from robot-environment interactions. Nevertheless, many existing automated domain generation techniques rely on some form of prior knowledge. For instance, some methods assume comprehensive natural language descriptions are available, while others depend on predefined sets of logical predicates or actions. This reliance on predefined information or initial domain elements can constrain the generalizability and scalability of automated planning domain generation in various applications.

Therefore, there is a need for systems and methods for (automatically) generating planning domains that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure describes systems and methods related to generating planning domains for guiding automated task execution, for example, for use in automated planning systems, such as robotic systems, autonomous driving, travel plan making etc. Embodiments include techniques for generating a predicate library comprising logical predicates relevant to a task description and an action library comprising logical actions based on inputs such as human demonstrations interpreted using the predicate library. These libraries may be generated automatically potentially without requiring any predefined logical predicates or actions (or any language-based descriptions of them), for example, by utilizing large language models and/or physical simulation. The predicate and action libraries may be generated automatically via physical simulation, thereby reducing or obviating the need for predefined logical predicates, actions, or any language-based descriptions of them. The generated predicate and action libraries may be compiled to produce a planning domain. The generated planning domain may subsequently be used by a task planner to generate task plans, and a logic-constrained action sampler (LoCAS) may utilize the task plan and the planning domain to generate corresponding motion plans subject to constraints derived from logical predicate effects.

According to embodiments, a method is provided for generating a planning domain. This planning domain may be useful for guiding automated task execution in various systems. The method includes one or more operations performed by, for example, a computing system. The method includes generating a predicate library. The predicate library may include logical predicates defining properties or relationships of objects relevant to a task description. The method further includes generating an action library. This action library may define logical actions, representing transitions between different logical states. These actions may be generated based on interpreting a human demonstration using the previously generated predicate library. The method further includes generating the planning domain by compiling the generated predicate library and the action library. The planning domain may be generated without requiring predefined logical predicates or predefined logical actions, which could offer flexibility and scalability compared to manual domain creation or other existing methods.

In some embodiments, generating the predicate library further includes identifying physically feasible object states through physical simulation of randomly sampled object states. In some embodiments, generating the predicate library further includes generating prompts based on descriptions of the physically feasible object states and the task description. In some embodiments, generating the predicate library further includes providing the prompts to a large language model (LLM) to generate first-order predicates relevant to the task description. This use of simulation and LLMs may facilitate the automated discovery of meaningful predicates from the environment and task context. The method may further allow for automatic generation of predicate library

In some embodiments, generating the predicate library further includes deriving higher-order predicates from the first-order predicates using logic operators or quantifiers. In some embodiments, generating the predicate library further includes including the first-order predicates and the higher-order predicates in the predicate library. This could potentially allow for a richer representation of the state space.

In some embodiments, generating the action library further includes mapping the human demonstration into a sequence of logical states using the predicate library. In some embodiments, generating the action library further includes extracting logical state transition pairs from the sequence of logical states, each pair representing a logical state before and a logical state after an inferred logical action within the human demonstration. In some embodiments, generating the action library further includes providing the logical state transition pairs as prompts to a large language model (LLM) to identify patterns in the logical state transitions and generate corresponding action definitions for the action library. This may enable automatic generation of action library without requiring predefined logical actions and further may allow for learning of action models from demonstrations.

In certain embodiments, the planning domain is generated in planning domain definition language (PDDL).

In some embodiments, the method further includes providing the generated planning domain and a new problem description to a task planner. In some embodiments, the task planner is one of a symbolic solver or an LLM task planner. In some embodiments, the method further includes generating, by the task planner, a task plan including a sequence of logical actions to address the new problem description based on the planning domain.

In some embodiments, the method further includes generating a motion plan based on the task plan using a logic-constrained action sampler (LoCAS).

In some such embodiments, generating the motion plan using the LoCAS includes, for an action in the task plan, identifying a logical predicate indicating an effect of the action. In some such embodiments, generating the motion plan using the LoCAS includes determining continuous state constraints corresponding to the identified logical predicate by querying predicate implications. In some such embodiments, generating the motion plan using the LoCAS includes performing motion planning subject to the determined continuous state constraints to generate the motion plan. This may help bridge the gap between symbolic planning and physical execution.

In some embodiments, querying predicate implications includes retrieving a set of inequalities corresponding to the identified logical predicate.

In some embodiments, performing motion planning includes using constrained sampling-based motion planning.

According to another aspect, a system is provided for generating a planning domain for guiding automated task execution. The system includes one or more processors and a memory storing instructions that, when executed by the one or more processors, configure the system to perform the operations of the method described herein, including the various embodiments thereof.

According to another aspect, an apparatus may be provided for generating a planning domain for guiding automated task execution, where the apparatus includes: a memory, configured to store a program; a processor, configured to execute the program stored in the memory, and when the program stored in the memory is executed, the processor is configured to perform one or more of the methods and systems described herein.

According to another aspect, a (e.g., non-transitory) computer readable medium may be provided, where the computer readable medium stores program code executed by a device and the program code is used to perform one or more of the methods and systems described herein.

According to another aspect, there may be provided a computer program, or computer program product, comprising stored thereon statements and/or instructions which, when executed by a computer processor perform one or more methods described herein.

According to another aspect, an apparatus or system is provided, where the apparatus includes modules configured to perform one or more methods described herein. According to another aspect, another apparatus is provided that includes computing electronics or processing circuitry and is configured to perform one or more methods described herein.

According to another aspect, a chip may be provided, where the chip includes a processor and a data interface, and the processor reads, by using the data interface, an instruction stored in a memory, to perform one or more of the methods described herein. Aspects may further include the memory. Additionally or alternatively, the chip may include electronics hardware such as digital circuits, analog circuits, or a combination thereof, which are configured to implement the operations as described herein.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates an overview of a framework for generating and utilizing a planning domain, according to an embodiment of the present disclosure.

FIG. 2 illustrates an example process for predicate imagination, according to an embodiment of the present disclosure.

FIG. 3 illustrates an example process for action generation, according to an embodiment of the present disclosure.

FIG. 4A illustrates an example process performed by a logic-constrained action sampler, according to an embodiment of the present disclosure.

FIG. 4B illustrates further detail regarding the translation of logical predicates into continuous state constraints within the process of FIG. 4A, according to an embodiment of the present disclosure.

FIG. 5 illustrates an overview of an alternative framework for generating and utilizing a planning domain, according to an embodiment of the present disclosure.

FIG. 6 illustrates an overview of a method for generating a planning domain, according to an embodiment of the present disclosure.

FIG. 7A illustrates an example hardware apparatus configured to implement embodiments described herein, according to an embodiment of the present disclosure.

FIG. 7B illustrates another example apparatus, potentially implemented as an integrated circuit or module, according to an embodiment of the present disclosure.

FIG. 7C illustrates an example apparatus comprising functional units, according to an embodiment of the present disclosure.

It will be noted that throughout the appended drawings, like features are identified by like reference numerals.

### DETAILED DESCRIPTION

The present disclosure relates generally to automated planning systems, such as those used for controlling robotic systems performing tasks in various environments and potentially other domains (e.g., autonomous driving, travel plan making, etc.) requiring automated planning based on generated symbolic models (e.g., generated planning domains). A challenge in developing such systems involves defining suitable planning domains, which includes the state representations (via predicates) and how actions transform that state (via action definitions including preconditions and effects) needed for automated task planning. Manually creating these domains can be complex and time-consuming, while existing automated approaches may face limitations, such as reliance on predefined knowledge. The embodiments described herein may provide techniques for automatically generating planning domains based on inputs like task descriptions and demonstrations, potentially without requiring predefined logical predicates or predefined logical actions.

Embodiments may include a framework or component for planning domain generation (referred to herein as Planning Domain Derived by LLM (PDDLLM)). This component may receive inputs, such as a description of a desired task and a demonstration of related actions. Based on these inputs, it generates parts of a planning domain, namely a predicate library defining relevant state properties and relationships, and an action library defining permissible actions and their effects on the state. These libraries are then compiled into a structured planning domain. Techniques involving physical simulation and large language models may be utilized within this framework to help identify relevant predicates and actions from the input data, potentially enabling domain generation from scratch.

The generated planning domain can subsequently be used for task execution. For instance, the domain may be provided to a task planner along with a description of a new problem. The task planner utilizes the domain to generate a high-level task plan, typically a sequence of logical actions. Embodiments may further include a component (referred to herein as a logic-constrained action sampler (LoCAS)) that translates this logical task plan into an executable low-level motion plan. The LoCAS component uses the generated planning domain, including the defined action effects and their corresponding predicate implications, to apply constraints during the motion planning process. This may facilitate the integration of high-level logical planning with low-level motion execution, which may ensure that physical actions satisfy their intended logical outcomes.

Robots can excel in structured settings with short-term, well-defined tasks but may struggle with long-horizon tasks that require abstract reasoning and adaptability. Task and Motion Planning (TAMP) frameworks can help by enabling robots to handle more complex, scalable decision-making. Task and motion planning may be understood as the process of integrating high-level task planning with low-level motion planning to enable a robot to perform complex and long-horizontal tasks in a dynamic environment.

However, a challenge in TAMP can be the manual creation of planning domains. A planning domain is a formal representation of the actions, states, and goals in a planning problem, typically defined using a standardized language, to guide the generation of a plan for achieving specific objectives. This manual creation process can be labor-intensive and may limit flexibility. Recent advancements in world model learning aim to address these issues by enabling automated generation of abstract world representations, potentially improving long-term decision-making without heavy manual input. Some approaches use natural language description of the predicates and actions for world abstraction, while others rely on symbolic representations like the Planning Domain Definition Language (PDDL).

The emergence of large pre-trained language models (LMs) has enhanced task planning capabilities, for example, through leveraging commonsense knowledge embedded in Large Language Models (LLMs) and Vision-Language Models (VLMs). While these LLM-based task planners may exhibit generalization across various tasks, they may still face limitations when handling complex, long-horizon planning tasks that require advanced reasoning.

In response, some efforts have involved using heuristics generated by LMs to improve task planning efficiency. These methods may integrate symbolic search strategies. Symbolic search may be understood as a search method (e.g., in AI) that explores a space of abstract symbols or representations to find solutions to a problem. These methods may integrate such strategies with LMs to potentially speed up the planning process or simplify the search space. Techniques can include using heuristics to prioritize potential states, focus on selecting feasible actions, or trim search trees to expedite task resolution. However, these approaches typically require the construction of symbolic planning domains before initiating the search tree, which can add complexity and constraints.

An alternative approach may be to eliminate the need for human-driven domain construction by automating the generation of symbolic planning domains. Some earlier methods employed optimization algorithms to infer symbolic elements. Such elements may include logical predicates. A logical predicate may define the logical property and condition of an object or specify object relationships via a classifier function that outputs true or false given the continuous state. Symbolic elements may also include logical actions. A logical action may be understood as an operator that can change the logical state of the world, and may be composed of a precondition (a set of predicates that are to be met to trigger the action) and a postcondition (indicating the state change after the action is executed). These optimization techniques, however, may suffer from high computational costs. More recently, the use of LMs for domain generation has been investigated. These approaches include building symbolic representations from natural language descriptions and learning additional predicates.

Some earlier work employs generate-and-test search methods to learn predicates and actions. Generate-and-test search typically creates candidate solutions and evaluates them, repeating the process until a valid solution is identified. Similarly, domain generation methods may generate candidate domains and assess them to identify an appropriate one.

Some recent work has started to exploit pre-trained LLMs and VLMs to generate planning domains and learn additional predicates. Some LLM-based methods use an LLM as a translator, interpreting natural language descriptions of the working environment into structured planning languages such as PDDL. Some VLM-based methods focus on learning additional predicates and actions from the interaction between a robot and the environment.

Current studies rely on prior knowledge of world abstractions, including comprehensive descriptions, symbolic predicates, and actions. Some studies assume comprehensive natural language descriptions of the abstract world are available. Some studies assume the availability of key predicates, while others rely on a complete set of predicates. Additionally, some approaches assume an initial set of predicates and actions is available. These assumptions may constrain the scalability and generalizability of such methods.

Embodiments described herein relate to the generation and utilization of planning domains for robotic systems. For example, embodiments may facilitate the generation of planning domains, such as those compatible with Planning Domain Definition Language (PDDL), potentially without requiring pre-designed logical predicates or logical actions. Further, embodiments may enhance the interpretability of the generated planning domain, which could enable later refinement or redesign. Additionally, embodiments may automate aspects of integrating the generated planning domain with low-level motion planners, which can assist in determining robot trajectories corresponding to logical actions.

Embodiments may generate planning domains potentially without requiring prior knowledge of the world abstraction (e.g., predefined predicates, actions, or comprehensive language descriptions). This may offer flexibility and scalability compared to methods reliant on such prior knowledge. Some embodiments provide a framework combining techniques such as random sampling, physical simulation, and Large Language Models (LLMs) to produce interpretable logical abstractions, potentially operating without needing prior knowledge or language descriptions of the abstract world. Physical simulation, in this context, may be understood as the process of using mathematical models to replicate real-world physical phenomena, allowing for the prediction and analysis of system behavior under various conditions.

Further embodiments relate to processes or techniques for extracting and compiling related predicates and actions into planning domains, such as PDDL planning domains, based on inputs like a limited number of human demonstrations (or only such inputs, e.g., only a limited number of human demonstrations). Additionally, embodiments may include a logic-constrained action sampler (LoCAS) component configured to perform motion planning by interfacing constraints imposed by the generated logical abstractions with motion planners.

The system according to some embodiments may operate without requiring a predefined set of logical predicates and actions. The logical predicates may be generated by pretrained large models and then generalized using first-order logic operators and quantifiers, potentially resulting in a particular predicate format or structure. The LoCAS component may automatically integrate logical-predicate constraints with motion planning functionalities. This integration may be coupled with the framework used for generating the planning domain (which may be referred to as PDDLLM in some embodiments), facilitating the application of logical constraints derived from predicate effects to the motion planning process.

One or more embodiments may apply to robotic planning systems that involve long-horizon task planning. Embodiments may generate PDDL planning domains usable for task planning in various downstream tasks based on inputs like human demonstrations (or only a limited number of human demonstrations). Example scenarios include applications involving industrial robots, service robots, navigation robots, and potentially others. Planning systems incorporating the described techniques may be included as part of products such as service robot planning systems.

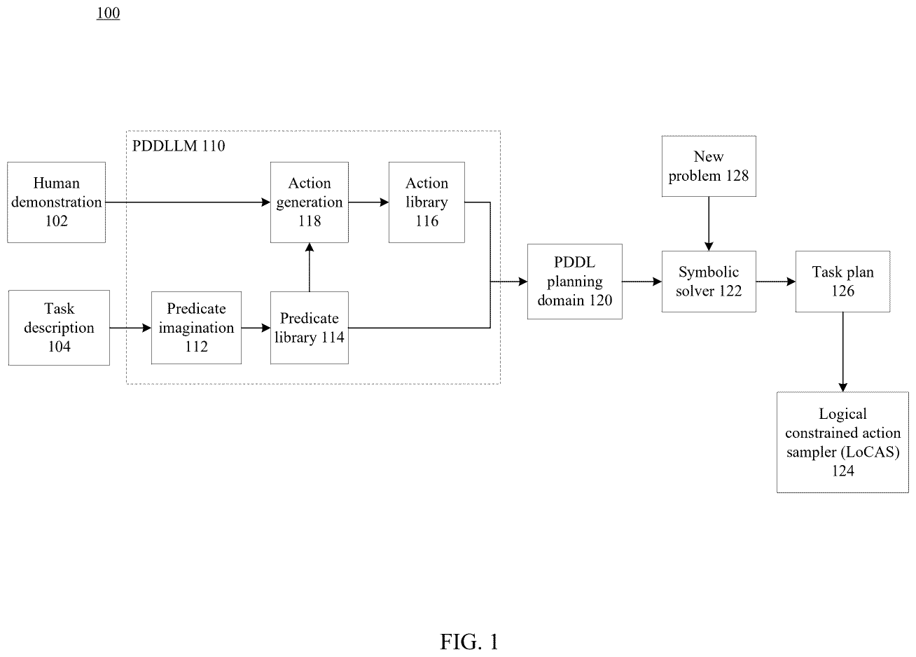

FIG. 1 illustrates an overview of a framework or system 100 for generating and using a planning domain according to an embodiment of the present disclosure. The framework 100 may include a planning domain generation component or unit, referred to as Planning Domain Derived by LLM (PDDLLM) 110.

According to an embodiment, the PDDLLM component 110 receives inputs, which may include a human demonstration 102 and a task description 104. Based on these inputs, the PDDLLM component 110 generates a planning domain 120.

In some embodiments, within the PDDLLM component 110, a predicate imagination module or unit 112 receives the task description 104. The predicate imagination module 112 may generate a predicate library 114 comprising logical predicates relevant to the task description 104. In some embodiments, an action generation module or unit 118 receives the human demonstration 102 and utilizes the predicate library 114 generated by the predicate imagination module 112. The action invention module 118 may generate an action library 116 comprising logical actions based on the human demonstration 102 as interpreted using the predicate library 114.

In some embodiments, the PDDLLM component 110 generates the planning domain 120 based on compiling the predicate library 114 and the action library 116. In some embodiments, the planning domain 120 may be generated in Planning Domain Definition Language (PDDL). The planning domain 120 may be generated without requiring predefined logical predicates or predefined logical actions.

The generated planning domain 120 can then be used for task planning. As shown in FIG. 1, the planning domain 120 may be provided, along with a new problem description 128, to a task planner, such as a symbolic solver 122. The symbolic solver 122 may use the planning domain 120 to generate a task plan 126, which may comprise a sequence of logical actions to address the new problem description 128.

The generated task plan 126 may subsequently be provided to a logic-constrained action sampler (LoCAS) 124. The LoCAS 124 can use the task plan 126, potentially in conjunction with the planning domain 120 (e.g., accessing predicate implications associated with action effects), to generate a corresponding motion plan for execution, for example, by a robotic system.

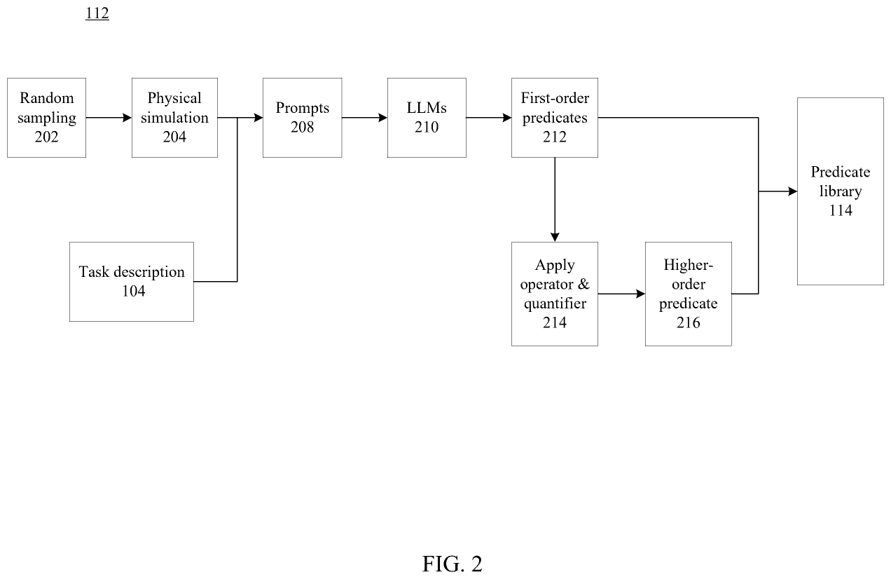

FIG. 2 illustrates an example process for predicate imagination, which may be performed by the predicate imagination module 112 shown in FIG. 1, according to some embodiments. The predicate imagination process 112 may involve one or more stages for generating the predicate library 114.

In a first stage, first-order predicates 212 may be generated. This stage may involve randomly sampling object states (e.g., positions, colors) via a random sampling block 202. Object states may be sampled across a feature space. The feature space may represent continuous state variables (e.g., position and color) that describe objects in an environment, with its boundary potentially corresponding to a real-world working space. Sampling may occur uniformly and randomly across the feature space to explore and cover a broad range of potential interactions and configurations between objects.

These sampled states can then be evaluated for physical feasibility using physical simulation 204. This simulation step may act as a filter, verifying whether the randomly sampled states adhere to physical laws. Infeasible states, such as those representing floating objects without support or overlapping objects, may be discarded, ensuring that subsequent processing focuses on physically plausible or feasible scenarios. In some implementations, the feature space may be discretized, for example, by partitioning dimensions into segments and computing intersections to form discrete subspaces (akin to grid cells). Analysis may identify subspaces containing feasible object states.

For the states deemed physically feasible (or subspaces containing them), descriptions may be generated. These descriptions can be combined with the task description 104 to form prompts 208. The prompts 208 may be provided to an LLM 210. The LLM 210 may process the prompts to summarize aspects of the feasible states or subspaces into meaningful logical predicates, identified as first-order predicates 212. This step may involve the LLM selecting and/or naming predicates that are relevant to the task description 104 based on the provided feasible state descriptions.

In some implementations, boundaries associated with subspaces may act as predicate implications, which can facilitate grounding continuous states into logical predicates. For example, the conditions defining these boundaries (e.g., mathematical inequalities defining the region of a subspace where a predicate holds true) may represent the implication of that predicate in the continuous domain. This stored or derivable relationship between the logical predicate name and its corresponding continuous boundary conditions (the implication) may allow the system to later determine whether a given continuous state satisfies a logical predicate (grounding) and forms the basis for applying logical constraints during motion planning (as used by LoCAS described herein).

In a second stage, the generated first-order predicates 212 may be utilized to derive higher-order predicates 216. This may involve applying logic operators or quantifiers via block 214 to the first-order predicates 212. For example, a predicate like (is_on, ?o₁, ?o₂) could potentially derive (not_is_on, ?o₁, ?o₂) when combined with a negation operator. These derived higher-order predicates 216 can enrich the representation by extending the descriptive capability of the first-order predicates 212, potentially allowing for the expression of more complex relationships about task-relevant properties of the environment.

The predicate library 114 (as shown in FIG. 1) may then be formed comprising the generated first-order predicates 212 and the derived higher-order predicates 216, which may provide a comprehensive set of logical terms for describing states relevant to the task.

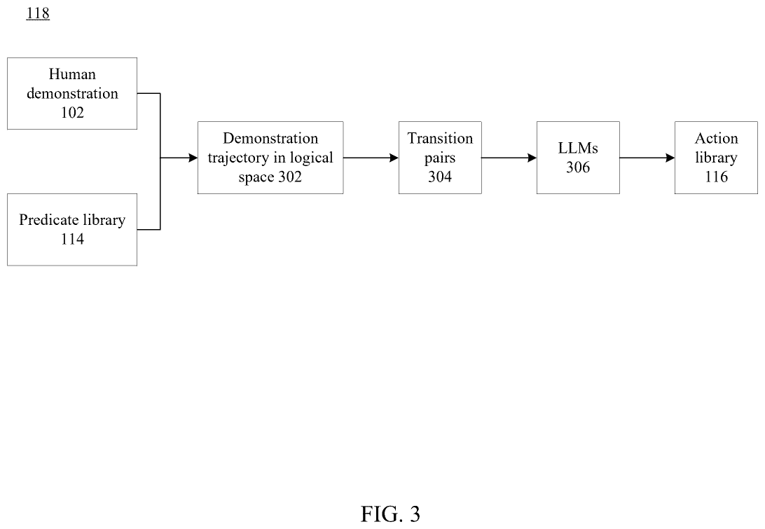

FIG. 3 illustrates an example process for action generation, which may be performed by the action generation module 118 shown in FIG. 1, according to some embodiments. This process may use the predicate library 114 (generated, for example, by the process of FIG. 2) and a human demonstration 102 to generate the action library 116.

After constructing the predicate library 114, the human demonstration 102, which may represent manipulation process over time (e.g., via coordinates or sensory data), can be mapped into a logical space representation. This mapping, represented by block 302, may involve interpreting the continuous state of the environment at different time steps during the demonstration by using the predicates available in the predicate library 114 to ground the predicates against the demonstration data at each time step. Grounding may involve determining the truth value (true or false) of relevant predicates based on the observed state in the demonstration data. This may result in a representation of the demonstration as a sequence or trajectory of logical states (sets of true predicates) over time.

From this demonstration trajectory in logical space 302, logical state transitions 304 may be extracted. This extraction may involve identifying changes between consecutive logical states in the sequence. Each transition may be represented as a pair, comprising the logical state before a change and the logical state after the change. Assuming the demonstrated actions are associated with state changes (e.g., the demonstrated actions are the sole cause of state changes), these logical state transitions may signify the effects of logical actions performed during the demonstration, and the action itself may be inferred from the state change.

These extracted transition pairs 304 may then be provided as input, potentially formatted as prompts, to an LLM 306. The LLM 306 may analyze these transition pairs to identify patterns (e.g., recurring patterns) in how the logical state changes. Based on these identified patterns, the LLM 306 may generate corresponding action definitions, which are collected into the action library 116. These definitions may indicate one or more of the following: the action's name, parameters, preconditions (logical conditions required for the action to be applicable), and effects (the logical state changes resulting from the action). The definitions may be formatted according to a specific syntax like PDDL.

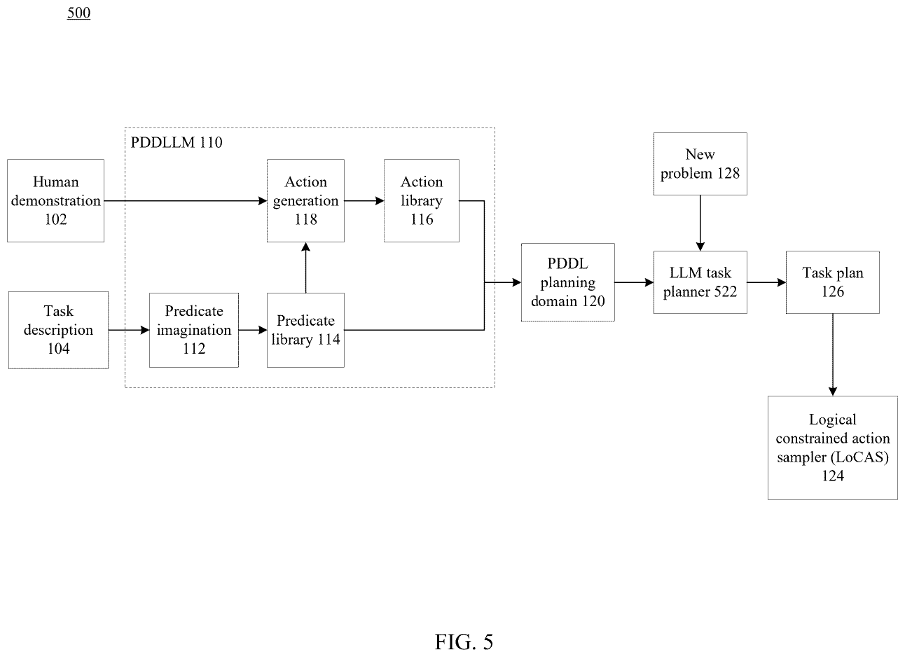

Following the generation of the action library 116 and predicate library 114, these libraries may be compiled into a planning domain 120 (e.g., a PDDL planning domain). As shown in FIG. 1 and FIG. 5, this planning domain 120 can be combined with a task planner (such as symbolic solver 122 or an LLM task planner 522) to generate task plans 126 for a given new problem description 128.

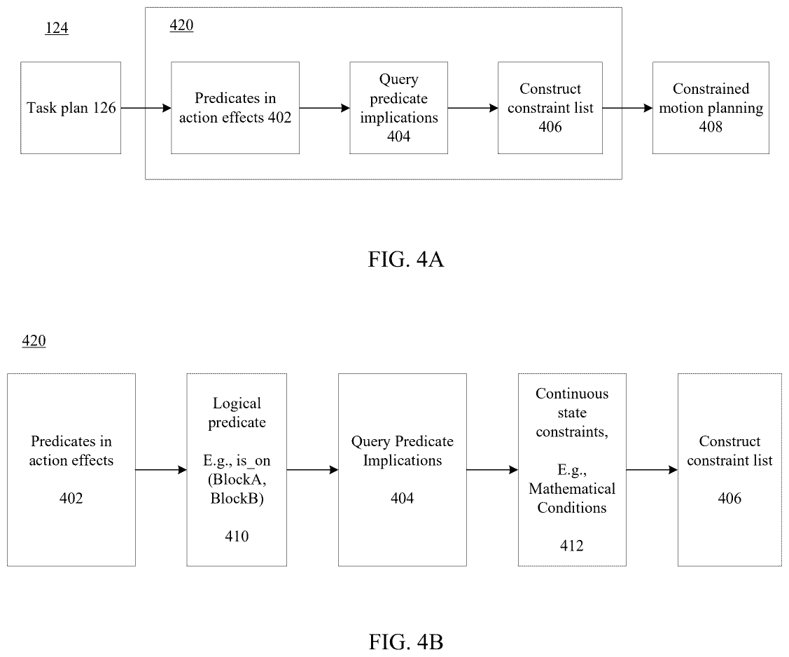

The generated task plan 126, which comprises a sequence of logical actions, may then be processed to generate a corresponding motion plan for execution by, for example, a robotic system. FIG. 4A illustrates an example process performed by a logic-constrained action sampler (LoCAS) 124. The LoCAS component 124 may act as an interface between the logical constraints and a motion planner, where the LoCAS translates the logical requirements of the task plan 126 into constraints suitable for a motion planner, thereby enabling the generation of a corresponding motion plan based on the task plan 126. The motion planner may be any motion planner publicly available.

According to an embodiment, the LoCAS 124 receives the task plan 126 as input. In some embodiments, for an action indicated or specified in the task plan 126, the LoCAS 124 identifies the logical predicate(s) indicated an effect(s) of that action, as shown by block 402. These effects may represent the desired logical state after the action is completed.

In some embodiments, the LoCAS 124 then determines the continuous state constraints corresponding to the identified logical predicate(s). As described herein, predicate implications, which may represent the mapping or rule translating logical predicates into their corresponding conditions in the continuous state space. Predicate implications may be stored as part of the predicate library 114, associated with their respective predicates. Determining the continuous state constraints may thus involve querying these implications predicate implications, as represented by block 404. This querying can be understood as a search or look up process within the predicate library 114. Given the name of an identified logical predicate effect, the corresponding stored implication may be retrieved. This retrieval may provide the continuous state constraints needed to translate the logical requirements into a format usable by motion planner. The continuous state constraints may be represented as a set of mathematical constraints, such as a set of inequalities, corresponding to the identified logical predicate effects.

These determined continuous state constraints may then be used to guide the motion planning process. Block 406 may represent the construction of a constraint list based on the determined continuous state constraints, which may then be passed to motion planner (potentially a standard or generic one). In some embodiments, motion planning is then performed, for example, for the robotic system, as indicated by block 408. This motion planning may be performed subject to the determined continuous state constraints (represented by list 406), which may ensure that the resulting motion plan, when executed, achieves the logical effects specified for the action. In some embodiments, the motion planning performed at block 408 uses constrained motion planning techniques (which may include but not limited to sampling-based motion planning techniques). This process may transform the logically constrained motion planning problem into a constrained motion planning problem solvable by techniques adapted to handle the derived constraints.

FIG. 4B illustrates further detail regarding a portion 420 of the LoCAS process of FIG. 4A, corresponding to the translation of logical predicates into continuous state constraints. The process portion 420 may begin with or use the identification of predicate(s) indicating effect(s) of an action (represented by block 402). To illustrate the translation process, FIG. 4B shows an example logical predicate 410 (e.g., is_on (BlockA, BlockB)) from the effect(s) identified in step 402, serving as input.

The logical predicate 410 may then be processed by querying predicate implications, represented by block 404. As described herein, this step may involve accessing or applying the mapping or rule (the implication) associated with the logical predicate 410 to determine its meaning in the continuous, physical domain. In some embodiments, the result of querying the predicate implications (404) is the determination of corresponding continuous state constraints 412. These constraints 412 may represent the mathematical conditions (e.g., equalities or inequalities relating positions and orientations) that define the physical state required to satisfy the logical predicate 410. As may be appreciated, if multiple predicate effects are identified in step 402, this translation process (404 determining 412) may be performed for each relevant predicate.

In some embodiments, the determined continuous state constraints 412 may then be used, for example, by providing them as input to the construct constraint list step, represented by block 406. At block 406, the constraints needed (potentially from multiple translated predicate effects) may be aggregated for the subsequent constrained motion planning step (408 in FIG. 4A).

FIG. 5 illustrates an overview of an alternative framework or system 500 for generating and utilizing a planning domain, according to some embodiments. The framework 500 shares similarities with the framework 100 described in FIG. 1, in terms of system design and function, for example, regarding the planning domain generation component, PDDLLM 110, and the logic-constrained action sampler (LoCAS) 124.

As described previously in relation to FIG. 1, the PDDLLM component 110 receives inputs such as a human demonstration 102 and a task description 104 and generates a planning domain 120 (e.g., a PDDL planning domain), potentially without requiring predefined predicates or actions. The internal processes for predicate imagination (112) to produce a predicate library (114) and action generation (118) to produce an action library (116) within PDDLLM 110 may be similar to those detailed in FIGS. 2 and 3.

In the embodiment shown in FIG. 5, the task planning process use a different component compared to the symbolic solver 122 shown in FIG. 1. In some embodiments, after the planning domain 120 is generated by the PDDLLM component 110, the planning domain 120 and a new problem description 128 are provided as input to a Large Language Model (LLM) task planner 522.

The LLM task planner 522 may process these inputs and use the planning domain 120 to generate a task plan 126. The task plan 126 may comprise a sequence of logical actions intended to address the new problem description 128 based on the rules and definitions within the planning domain 120.

Following the generation of the task plan 126 by the LLM task planner 522, the task plan 126 may subsequently be provided to the LoCAS 124. The LoCAS 124 can then generate a corresponding motion plan based on the task plan 126, potentially using processes similar to those described in relation to FIGS. 4A and 4B.

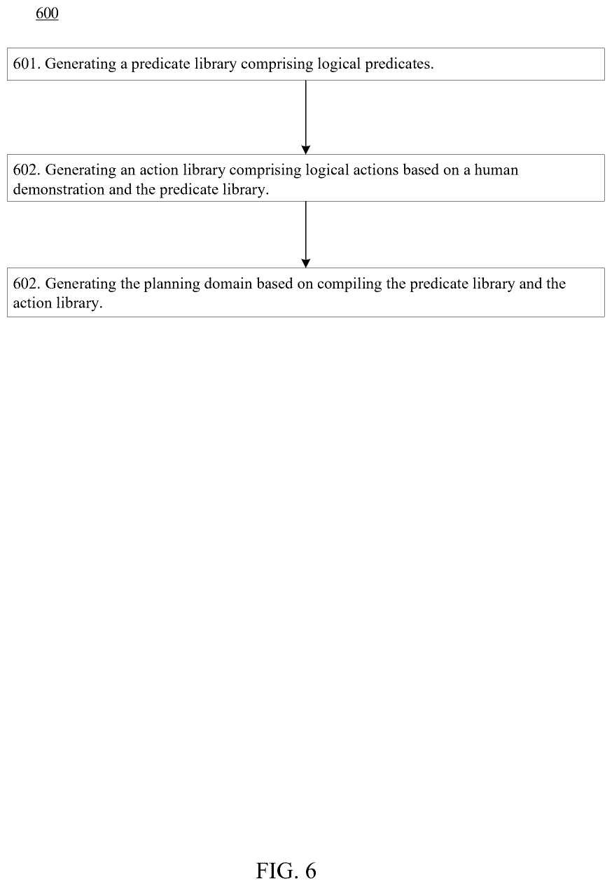

FIG. 6 illustrates a high-level overview of a method 600 for generating a planning domain, such as planning domain 120 shown in FIG. 1 and FIG. 5, according to an embodiment of the present disclosure. This method may be performed, for example, by the PDDLLM component 110 or a similar system configured for use in task and motion planning. The generated planning domain may be used for guiding automated task execution. The method may allow for transforming inputs like task description(s) and human demonstration(s) into a planning domain usable by automated planning system. The method aims to automate domain generation, potentially overcoming limitations of manual creation or reliance on predefined symbolic knowledge.

The method 600 includes, at 601, generating a predicate library 114. This library may include logical predicates that define properties or relationships of objects relevant to a given task description 104. As described in reference to FIG. 2, this step may involve processes such as identifying physically feasible object states (potentially using random sampling 202 and physical simulation 204) and using LLM 210 based on prompts 208 derived from these feasible states and the task description to generate first-order predicates 212. This step may further involve deriving higher-order predicates 216 from the first-order predicates using logic operators or quantifiers (e.g., via block 214), with both types of predicates being included in the resulting predicate library.

In some embodiments, method 600 further includes, at 602, generating an action library 116. This library may comprise logical actions that define transitions between logical states. The generation of the action library may be based on input such as human demonstration 102 interpreted using the predicate library generated at 601. As described in reference to FIG. 3, this step may involve mapping the human demonstration into a sequence of logical states 302 by grounding the predicates from the library against the demonstration data, extracting logical state transition pairs 304 representing changes between states, and providing these pairs as prompts to an LLM 306. The LLM may then identify patterns in these transitions to generate corresponding action definitions (which may include one or more of name, parameters, preconditions, and effects) for the action library.

In some embodiments, method 600 further includes at 603, generating the planning domain 120. This may be achieved by compiling the predicate library generated at 601 and the action library generated at 602. In some embodiments, the planning domain may be generated without requiring predefined logical predicates or predefined logical actions, as the predicates and actions are generated based on the provided inputs (task description, human demonstration) and internal processes (simulation, LLM processing, logical derivation). In some embodiments, the resulting planning domain may be formatted in a standard language such as PDDL. The generated planning domain can subsequently be used by a task planner (e.g., symbolic solver 122 or LLM task planner 522) to generate task plans for new problems to guide automated task execution, as described in relation to FIG. 1 and FIG. 5. While described in the context of robotics, the generated planning domain and the method 600 for its creation may have broader applicability. For instance, the generated planning domain could guide decision-making in autonomous driving systems. Similarly, the planning domain could be used in software-based personal assistants to plan complex sequence of actions like scheduling, and for other automated systems requiring task planning capabilities.

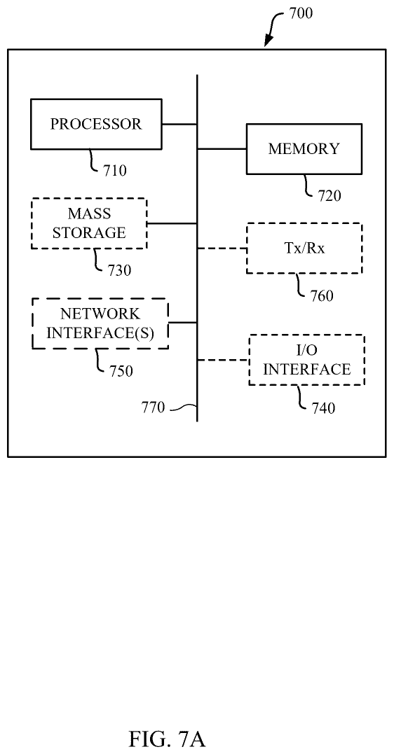

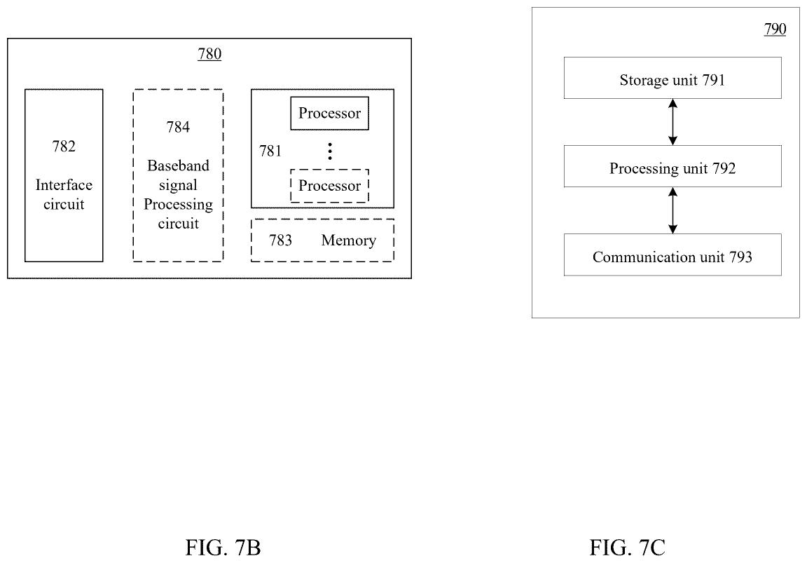

FIG. 7A illustrates an example apparatus 700 that may perform any or all of the operations of the methods and features described herein (e.g., methods related to FIGS. 1-6), according to different embodiments of the present disclosure. For example, a computer, a robotic controller, or other processing system may be configured as the apparatus 700. The apparatus 700 could represent the overall system (e.g., system 100 or 500) or one or more components or modules described herein, such as the PDDLLM component 110, the predicate imagination module 112, the action generation module 118, the task planner (122 or 522), or the LoCAS component 124. In some embodiments, apparatus 700 may perform one or more operations described in relation to FIGS. 1-6.

As shown, the apparatus 700 may include one or more processors 710, such as a Central Processing Unit (CPU), Graphics Processing Unit (GPU), Artificial Intelligence (AI) processor, or other processing unit. The apparatus 700 may also include memory 720, non-transitory mass storage 730, and an input-output (I/O) interface 740. These components may be communicatively coupled via a bi-directional bus 770 or other interconnection mechanisms. Depending on the implementation (e.g., if integrated into a robot or communicating with external resources), components like a network interface 750 or a communication transceiver 760 might also be included. According to certain aspects, any or all of the depicted elements may be utilized, or only a subset of the elements. Further, apparatus 700 may contain multiple instances of certain elements, such as multiple processors or memories. Elements may also be directly coupled. Additionally, or alternatively to a processor and memory, other processing electronics, such as integrated circuits (ICs), application-specific integrated circuits (ASICs), field-programmable gate arrays (FPGAs), digital circuitry, analog circuitry, chips, dies, multichip modules, substrates, or a combination thereof may be employed for performing the required logical operations described herein (e.g., predicate/action generation, domain compilation, task planning, LoCAS operations).

The memory 720 may include any type of non-transitory memory such as static random-access memory (SRAM), dynamic random-access memory (DRAM), synchronous DRAM (SDRAM), read-only memory (ROM), flash memory, or any combination thereof. The mass storage 730 may include any type of non-transitory storage device, such as a solid-state drive (SSD), hard disk drive (HDD), magnetic disk drive, optical disk drive, USB drive, or any computer program product configured to store data and machine-executable program code. According to certain aspects, the memory 720 or mass storage 730 may have recorded thereon statements and instructions executable by the processor 710 for performing any method operations described herein, such as the steps illustrated in FIGS. 1-6. For example, instructions corresponding to the PDDLLM component 110 (including predicate imagination 112 and action generation 118), the task planner (122 or 522), and the LoCAS component 124 may be stored. The memory 720 or mass storage 730 may also store data utilized or generated by these operations, such as predicate libraries 114, action libraries 116, planning domains 120, task plans 126, motion plans, or predicate implications. The I/O interface 740 may be used for receiving inputs like human demonstrations (102), task descriptions (104), new problem descriptions (128), or sensor data, and for outputting results like generated planning domains (120), task plans (126), or motion plans (e.g., to robot actuators).

FIG. 7B illustrates an example apparatus 780 according to an embodiment of the present disclosure, which could be implemented within apparatus 700 or as a standalone component or module (e.g., representing a functional block like LoCAS 124 or an LLM processor). For example, the apparatus 780 may be implemented as an integrated circuit, chip, system-on-chip (SoC), system-in-package (SiP), or a multi-chip module, potentially including processing electronics tailored for one or more tasks described herein (e.g., LLM processing, physical simulation (204), motion planning (408)). The apparatus 780 can include one or more integrated circuits and potentially other discrete components.

In an example, the apparatus 780 may include one or more processors 781 and an interface circuit 782. The apparatus 780 may further include memory 783. The one or more processors 781 are configured to execute computer program instructions, potentially stored wholly or partly in memory 783, to implement related operations described in the method embodiments herein (e.g., steps 601, 602, 603 of FIG. 6). The memory 783 is configured to store corresponding computer program instructions and/or data (e.g., predicate libraries 114, action libraries 116, planning domains 120, predicate implications). The interface circuit 782 may be configured to implement communication with other components, such as sensors, actuators, other processors, or external systems (e.g., via the I/O interface 740 or bus 770 of apparatus 700). Optionally, specialized processing circuits 784 (e.g., GPU, AI accelerator, FPGA, DSP) may be included to handle specific computationally intensive tasks relevant to the embodiments, such as physical simulation (204), LLM processing (210, 306), or motion planning computations (408).

The apparatus 780 may correspond to the processor 710 or be included within the processor 710 in some scenarios. It may be implemented as a chip or packaged with other chips (e.g., into an SoC or SiP).

FIG. 7C illustrates another example apparatus 790 according to an embodiment of the present disclosure, representing a functional unit perspective. The apparatus 790 may include corresponding modules or units configured to implement methods described herein. In some implementations, the apparatus 790 includes a processing unit 792 and optionally a communication unit 793 and/or a storage unit 791.

The apparatus 790 may represent the apparatus 700 or be part of apparatus 700 (e.g., representing logical modules like PDDLLM 110 or LoCAS 124 or other components). The processing unit 792 may correspond to the processor 710 or processing electronics described for apparatus 700, configured to execute the logic for the described functions. The optional communication unit 793 may correspond to interfaces like I/O interface 740 or network interface 750, facilitating communication with external systems, sensors, or actuators. The optional storage unit 791 may correspond to memory 720 or mass storage 730, configured to store instructions and/or data related to the described embodiments (e.g., instructions for PDDLLM 110, LoCAS 124; data like predicate library 114, action library 116).

A function of the apparatus 790 may be implemented by one or more processors (as described in relation to 710 or 781), potentially including specialized processors like GPUs, AI processors (e.g., NPUs), or FPGAs suitable for tasks like LLM inference or simulation. In some implementations, when the apparatus 790 is implemented as a circuit or chip (e.g., SoC, ASIC, FPGA), the function of the processing unit 792 may be implemented by a circuit system within the chip, and the function of the communication unit 793 may be implemented by an interface circuit on the chip.

It may be understood that the units (791, 792, 793) in the apparatus 790 may be logical or functional. Functions may correspond to one unit or be integrated. Units may be integrated into a single physical entity or distributed. Functional units may be implemented in hardware, software, or a combination thereof. Implementation choices depend on particular applications and design constraints. Functional units may be configured as one or more integrated circuits such as ASICs, CPUs, MPUs, MCUs, DSPs, FPGAs, or combinations thereof. The storage unit 791 may include various types of volatile or non-volatile memory (RAM, ROM, flash, etc.). The processing unit 792 may include various types of processing cores (CPU, DSP, MPU, MCU, GPU, FPGA, AI processor, NPU, etc.). Memory or storage units may store computer program instructions which, when executed by the processing unit 792, perform steps described in the method embodiments herein (e.g., FIGS. 1-6).

According to embodiments, pretrained large models are used to extract logical predicates and logical actions from inputs such as human demonstrations, facilitating the creation of a planning domain. Such an approach may operate without prior knowledge of logical predicates or actions, which may enhance generalizability and scalability compared to methods reliant on such prior knowledge. Furthermore, embodiments may improve the interpretability of the generated planning domain, potentially facilitating human-in-the-loop reactive design and refinement processes.

Additionally, embodiments may include a Logic-Constrained Action Sampler (LoCAS) framework. The LoCAS framework may be configured to apply logical constraints, derived from logical predicates, to a motion planner. The LoCAS framework may automate aspects of the integration between generated planning domains and low-level motion planners, which may potentially increase system autonomy and robustness.

While various embodiments are described herein in the context of task and motion planning for robotic systems (including industrial, service, or navigation robots), it is to be understood that the techniques for generating planning domains based on inputs like demonstrations and task descriptions, potentially without predefined predicates or actions, may have broader applicability. The principles described may also be adapted for use in other fields requiring automated planning or decision-making based on generated symbolic models.

For example, potential applications may include the field of autonomous driving. The PDDLLM framework could potentially automate aspects of generating traffic navigation plans, which may involve complex decision-making scenarios (e.g., determining when to stop, yield, or merge). Such a system could potentially adapt the generated planning domains based on factors like the local environment, road conditions, and applicable traffic rules.

As another example, embodiments may be utilized in software or AI-based personal assistants. The PDDLLM framework could potentially enable such assistants to understand and generate planning domains for new task types, such as scheduling meetings, ordering groceries, or managing household devices. The generation of these task domains could be based on factors like user preferences and environmental context.

Accordingly, references to robotic systems or specific examples provided herein are intended to be illustrative. The described techniques for automated planning domain generation and utilization may be implemented in various systems and contexts beyond those explicitly detailed, and the scope of the disclosure should not be construed as limited to the examples presented.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

Although the present disclosure has been described with reference to specific features and embodiments thereof, it is clear that a person skilled in the art can make various modifications and variations to this application without departing from the scope of this disclosure. The specification and drawings are, accordingly, to be regarded simply as an illustration of embodiments as defined by the appended claims, and are contemplated to cover any and all modifications, variations, combinations or equivalents that fall within the scope of the present disclosure.

What is claimed is:

1. A computer-implemented method for generating a planning domain for guiding automated task execution, the method comprising:
generating a predicate library comprising logical predicates defining properties or relationships of objects relevant to a task description;
generating an action library comprising logical actions defining transitions between logical states based on a human demonstration interpretable using the predicate library; and
generating the planning domain based on compiling the predicate library and the action library, the planning domain being generated without requiring predefined logical predicates or predefined logical actions.

2. The method of claim 1, wherein generating the predicate library further comprises:
identifying physically feasible object states through physical simulation of randomly sampled object states;
generating prompts based on descriptions of the physically feasible object states and the task description; and
providing the prompts to a large language model (LLM) to generate first-order predicates relevant to the task description.

3. The method of claim 2, wherein generating the predicate library further comprises:
deriving higher-order predicates from the first-order predicates using logic operators or quantifiers; and
including the first-order predicates and the higher-order predicates in the predicate library.

4. The method of claim 1, wherein generating the action library further comprises:
mapping the human demonstration into a sequence of logical states using the predicate library;
extracting logical state transition pairs from the sequence of logical states, each pair representing a logical state before and a logical state after an inferred logical action within the human demonstration; and
providing the logical state transition pairs as prompts to a large language model (LLM) to identify patterns in the logical state transitions and generate corresponding action definitions for the action library.

5. The method of claim 1, wherein the planning domain is generated in planning domain definition language (PDDL).

6. The method of claim 1, further comprising:
providing the generated planning domain and a new problem description to a task planner, the task planner being one of a symbolic solver or a large language model (LLM) task planner; and
generating, by the task planner, a task plan comprising a sequence of logical actions to address the new problem description based on the planning domain.

7. The method of claim 6, further comprising: generating a motion plan based on the task plan using a logic-constrained action sampler (LoCAS).

8. The method of claim 7, wherein generating the motion plan using the LoCAS comprises:
for an action in the task plan, identifying a logical predicate indicating an effect of the action;
determining continuous state constraints corresponding to the identified logical predicate by querying predicate implications; and
performing motion planning subject to the determined continuous state constraints to generate the motion plan.

9. The method of claim 8, wherein querying predicate implications comprises retrieving a set of inequalities corresponding to the identified logical predicate.

10. The method of claim 8, wherein performing motion planning comprises using constrained sampling-based motion planning.

11. A system for generating a planning domain for guiding automated task execution, the system comprising one or more processors and a memory storing instructions that, when executed by the one or more processors, configure the system to:
generate a predicate library comprising logical predicates defining properties or relationships of objects relevant to a task description;
generate an action library comprising logical actions defining transitions between logical states based on a human demonstration interpretable using the predicate library; and
generate the planning domain based on compiling the predicate library and the action library, wherein the planning domain is generated without requiring predefined logical predicates or predefined logical actions.

12. The system of claim 11, wherein the one or more processors configured to generate the predicate library are further configured to:
identify physically feasible object states through physical simulation of randomly sampled object states;
generate prompts based on descriptions of the physically feasible object states and the task description; and
provide the prompts to a large language model (LLM) to generate first-order predicates relevant to the task description.

13. The system of claim 12, wherein the one or more processors configured to generate the predicate library are further configured to:
derive higher-order predicates from the first-order predicates using logic operators or quantifiers; and
include the first-order predicates and the higher-order predicates in the predicate library.

14. The system of claim 11, wherein the one or more processors configured to generate the action library are further configured to:
map the human demonstration into a sequence of logical states using the predicate library;
extract logical state transition pairs from the sequence of logical states, each pair representing a logical state before and a logical state after an inferred logical action within the human demonstration; and
provide the logical state transition pairs as prompts to a large language model (LLM) to identify patterns in the logical state transitions and generate corresponding action definitions for the action library.

15. The system of claim 11, wherein the planning domain is generated in planning domain definition language (PDDL).

16. The system of claim 11, wherein the one or more processors are further configured to:
provide the generated planning domain and a new problem description to a task planner, the task planner being one of a symbolic solver or a large language model (LLM) task planner; and
generate, via the task planner, a task plan comprising a sequence of logical actions to address the new problem description based on the planning domain.

17. The system of claim 16, wherein the one or more processors are further configured to:
generate a motion plan based on the task plan using a logic-constrained action sampler (LoCAS).

18. The system of claim 17, wherein the one or more processors configured to generate the motion plan using the LoCAS are further configured to:
for an action in the task plan, identify a logical predicate indicating an effect of the action;
determine continuous state constraints corresponding to the identified logical predicate by querying predicate implications; and
perform motion planning subject to the determined continuous state constraints to generate the motion plan.

19. The system of claim 18, wherein the one or more processors configured to determine continuous state constraints by querying predicate implications are further configured to retrieve a set of inequalities corresponding to the identified logical predicate.

20. A non-transitory computer-readable medium storing instructions that, when executed by one or more processors of a system configured for generating a planning domain for guiding automated task execution, cause the one or more processors to perform operations comprising:
generating a predicate library comprising logical predicates defining properties or relationships of objects relevant to a task description;
generating an action library comprising logical actions defining transitions between logical states based on a human demonstration interpretable using the predicate library; and
generating the planning domain based on compiling the predicate library and the action library, wherein the planning domain is generated without requiring predefined logical predicates or predefined logical actions.
